(19) United States
(12) Patent Application Publication
(10) Pub. No.: US 2005/0213747 A1
(43) Pub. Date: Sep. 29, 2005

(54) Hybrid monaural and multichannel audio for conferencing

(75) Inventors: Steven Popovich, Little Chute, WI (US); Steven Barnes, Austin, TX (US)

Correspondence Address: FORTKORT GRETHER + KELTON LLP, 8911 N. CAPITAL OF TEXAS HWY., SUITE 3200, AUSTIN, TX, 78759, US

(73) Assignee: VTEL Products, Inc.

(21) Appl. No.: 10/959,414

(22) Filed: Oct. 6, 2004

Related U.S. Application Data
(60) Provisional application No. 60/509,506, filed on Oct. 7, 2003.

(51) Int. Cl. H04M 9/08

(52) U.S. Cl. 379/406.03; 379/406.1

(57) ABSTRACT

A method including several steps is provided for selectively combining single-channel and multi-channel signals for loudspeaker output. A single-channel signal (54) is created (208) based on an inbound multi-channel signal (32, 36). A local voice activity level and a remote voice activity level are detected (210). If the remote voice activity level dominates the local voice activity level, α is set equal to a first percentage (212). Otherwise, α is set equal to a second percentage higher than the first percentage (214). At least one loudspeaker output signal (22, 24) is mixed comprising a proportion of the single-channel signal based on α and a proportion of the inbound multi-channel signal based on 1−α. A computer program product is also provided for the preceding method. An apparatus is also provided, including a receive combiner (52), a sound activity monitor (72), a mix and amplitude selector (56), and a monaural and stereo mixer (78). A system is also provided having a receive channels analysis filter (120).

### CROSS-REFERENCE TO RELATED PATENT APPLICATIONS

This patent application claims the benefit of U.S. Provisional Patent Application No. 60/509,506, entitled, “Hybrid Monaural and Multichannel Audio for Conferencing,” and filed Oct. 7, 2003.

### TECHNICAL FIELD OF THE DISCLOSURE

This disclosure pertains generally to the field of multimedia conferencing and, more specifically, to improving the quality of audio conferencing.

### BACKGROUND OF THE DISCLOSURE

Audio conferencing has long been an important business tool, both on its own and as an aspect of videoconferencing. The simplest form of audio conferencing utilizes a single channel to convey monaural audio signals. However, a significant drawback is that such single-channel audio conferencing fails to provide listeners with cues indicating speakers' movements and locations. The lack of such direction of arrival cues results in single-channel audio conferencing failing to meet the psychoauditory expectations of listeners, thereby providing a less desirable listening experience.

Multi-channel audio conferencing surpasses single-channel audio conferencing by providing direction of arrival cues, but attempts at implementing multi-channel audio conferencing have been plagued with technical difficulties. In particular, when the output of local speakers is picked up by local microphones, acoustic echoes result which detract from the listening experience. Acoustic echoes in a multi-channel audio conferencing system are more difficult to cancel than in a single-channel audio conferencing system, because each speaker-microphone pair produces a unique acoustic echo. A set of filters can be utilized to cancel the acoustic echoes of all such pairs in a multi-channel audio conference system. Adaptive filters are typically used where speaker movement can occur. However, the outputs of local speakers are highly correlated with each other, often leading such adaptive filter sets to misconverge (i.e., present a mathematical problem having no well-defined solution).

Several approaches to the misconvergence problem have been implemented to decorrelate local speaker outputs. One approach adds a low level of uncorrelated noise. Another approach employs non-linear functions on various channels. Yet another approach adds spatializing information to channels. However, all of these approaches can present complexity issues and introduce audio artifacts to varying degrees, thereby lowering the quality of the resulting listening experience.

There is thus a need in the art for an audio conferencing method and system that provides listeners with direction of arrival cues, while mitigating the misconvergence problems noted above. There is further a need in the art for such a method and system that do not present the complexity and artifact issues of the decorrelation approaches discussed above. These and other needs are met by the systems and methodologies provided herein and hereinafter described.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 depicts a block diagram of an audio conferencing system set up for stereo audio conferencing at a typical site, in accordance with an embodiment of the present invention.

FIG. 2 depicts a process flow diagram of an audio conferencing method for varying the proportion of single-channel vs. multi-channel output of local loudspeakers, in accordance with an embodiment of the present invention.

FIG. 3A depicts a block diagram of an audio processing system, in accordance with an embodiment of the present invention.

FIG. 3B depicts a transmit channels combiner, in accordance with an embodiment of the present invention.

FIG. 4 depicts flowcharts for processing both receive and transmit audio channels, in accordance with an embodiment of the present invention.

FIG. 5 depicts an arrangement for using the methods of the present invention for multiple frequency sub-bands in parallel, in accordance with an embodiment of the present invention.

FIG. 6 depicts a block diagram of an audio conferencing system using a stereo audio conferencing system to create virtual local locations for sound sources that originate in remote locations, in accordance with an embodiment of the present invention.

### DETAILED DESCRIPTION

The present disclosure provides a method and system for selectively combining single-channel and multi-channel audio signals for output by local peakers such that a percentage (α) of such output is single-channel, while the balance (1−α) is multi-channel. The acoustic echo problems associated with multi-channel audio conferencing are particularly difficult to resolve when the voice activity of local participants is concurrent with, or dominates, the voice activity of remote participants. Moreover, direction of arrival cues have the greatest impact on the listening experience of local participants when the audio conference is being dominated by the voice activity of remote participants.

It has now been found that both of these problems may be addressed by selecting the percentage (α) such that the outputs of local speakers are proportionally more single-channel when the voice activity of local participants is concurrent with, or dominates, that of remote participants, and is proportionally more multi-channel when the voice activity of remote participants is dominating the audio conference.

More particularly, a method is provided herein for selectively combining single-channel and multi-channel signals for speaker output. A single-channel signal is created based on an inbound multi-channel signal. A local voice activity level and a remote voice activity level are detected. If the remote voice activity level dominates the local voice activity level, α is set equal to a first percentage. Otherwise, α is set equal to a second percentage higher than the first percentage. At least one speaker output signal is mixed comprising a proportion of the single-channel signal based on α and a proportion of the inbound multi-channel signal based on 1−α. A computer program product is provided having logic stored on memory for performing the steps of the preceding method.

An apparatus is also provided herein for selectively combining single-channel and multi-channel signals for loudspeaker output. The apparatus comprises (a) a receive combiner configured to create a combined monaural signal from at least two inbound channel signals, (b) a sound activity monitor configured to produce a first state signal if the at least two inbound signal's source dominates an internal transmit signal's source, (c) a mix and amplitude selector adapted to output an α signal representing a first value if the first state signal is received and, otherwise, a second value higher than the first value, and (d) a monaural and stereo mixer adapted to output a loudspeaker signal comprising a proportion of the combined monaural signal based on α and a proportion of the at least two inbound channel signals based on 1−α. A system is also provided that includes a receive channels analysis filter adapted to direct an inbound multi-channel signal to one of a plurality of apparatuses based on the inbound multi-channel signal's frequency.

A main objective in multimedia conferencing is to simulate as many aspects of in-person contact as possible. Current systems typically combine full-duplex one-channel (monaural) audio conferencing with visual data such as live video and computer graphics. However, an important psychoacoustic aspect of in-person interaction is that of perceived physical presence and/or movement. The perceived direction of a voice from a remote site assists people to more easily determine who is speaking and to better comprehend speech when more than one person is talking. While users of multimedia conferencing systems that include live video can visually see movement of individuals at remote sites, the corresponding audio cues are not presented when using a single audio channel.

A multi-channel audio connection between two or more sites projects a sound wave pattern that produces a perception of sound more closely resembling that of in-person meetings. Two or more microphones are arranged at sites selected to transmit multi-channel audio and are connected to communicate with corresponding speakers at sites selected to receive multiple channels. Microphones and loudspeakers at the transmitting and receiving sites are positioned to facilitate the reproduction of direction of arrival cues and minimize acoustic echo.

The vast majority of practical audio conferencing systems, monaural or multi-channel, must address the problem of echoes caused by acoustic coupling of speaker output into microphones. Audio information from a remote site drives a local speaker. The sound from the speaker travels around the local site producing echoes with various delays and frequency-dependent attenuations. These echoes are combined with local sound sources into the microphone(s) at the local site. The echoes are transmitted back to the remote site, where they are perceived as disruptive noise.

An acoustic echo canceller (AEC) is used to remove undesirable echoes. An adaptive filter within the AEC models the acoustical properties of the local site. This filter is used to generate inverted replicas of the local site echoes, which are summed with the microphone input to cancel the echoes before they are transmitted to the remote site. An AEC attenuates echoes of the speaker output that are present in the microphone input by adjusting filter parameters. These parameters are adjusted using an algorithm designed to minimize the residual signal obtained after subtracting estimated echoes from the microphone signal(s) (for more details, see “Introduction to Acoustic Echo Cancellation”, presentation by Heejong Yoo, Apr. 26, 2002, Georgia Institute of Technology, Center for Signal and Image Processing, [retrieved on 2003-09-05 from <URL: http://csip.ece.gatech.edu/Seminars/PowerPoint/sem13_{—}04_{—}26_{—}02_HeeJong_%20Yoo.pdf>]).

In the case of monaural audio conferencing, a single channel of audio information is emitted from one or more speakers. An AEC must generate inverted replicas of the local site echoes of this information at the input of each microphone, which requires creating an adaptive filter model for the acoustic path to each microphone. For example, a monaural system with two microphones at the local site requires two adaptive filter models. In the case of stereo (two channels) or systems having more than two channels of audio information, an AEC must generate inverted replicas of the local site echoes of each channel of information present at each of the microphone inputs. The AEC must create an adaptive filter model for each of the possible pairs of channel and microphone. For example, a stereo system with two microphones at the local site requires four adaptive filter models.

Real-time multi-channel AEC is complicated by the fact that the multiple channels of audio information are typically not independent—they are correlated. Thus, a multi-channel AEC cannot search for echoes of each of these channels independently in a microphone input (for more details, see “State of the art of stereophonic acoustic echo cancellation.”, P. Eneroth, T. Gaensler, J. Benesty, and S. L. Gay, Proceedings of RVK 99, Sweden, June 1999, [retrieved on 2003-09-23 from <URL: http://www.bell-labs.com/user/slg/pubs.html> and <URL: http://www.bell-labs.com/user/slg/rvk99.pdf>.]).

A partial solution of this problem is to pre-train a multi-channel AEC by using each channel independently during training. The filter models are active, but not adaptive, during an actual conference. This is reasonably effective in canceling echoes from walls, furniture, and other static structures whose position does not change much during the conference. But the presence and movement of people and other changes which occur in real-time during the conference do affect the room transfer function and echoes.

Another approach to this problem is to deliberately distort each channel so that it may be distinguished, or decorrelated, from all other channels. This distortion must sufficiently distinguish the separate channels without affecting the stereo perception and sound quality—an inherently difficult compromise (one example of this approach may be found in U.S. Pat. No. 5,828,756, “Stereophonic Acoustic Echo Cancellation Using Non-linear Transformations”, to Benesty et al.).

The methodologies and devices disclosed herein enable effective acoustic echo canceling (AEC) for multi-channel audio conferencing. Users experience the spatial information advantage of multi-channel audio, while the cost and complexity of the necessary multi-channel AEC is close to that of common monaural AEC.

In one preferred embodiment, an audio processing system is provided which monitors the sound activity of sources at all sites in a conference. When local sound sources are quiet and local participants are listening most carefully, the audio processing system enables the reception of multi-channel audio with the attendant benefits of spatial information. When other conditions occur, the system smoothly transitions to predominantly monaural operation. This hybrid monaural and multi-channel operation simplifies acoustic echo cancellation. A pre-trained multi-channel acoustic echo canceller (AEC) operates continuously. Monaural AEC operates in parallel with the multi-channel AEC, adaptively training in real-time to account for almost all of the changes in echoes that occur during the conference. Real-time, adaptive multi-channel AEC with its high cost and complexity is not necessary.

Other aspects, objectives and advantages of the invention will become more apparent from the remainder of the detailed description when taken in conjunction with the accompanying drawings.

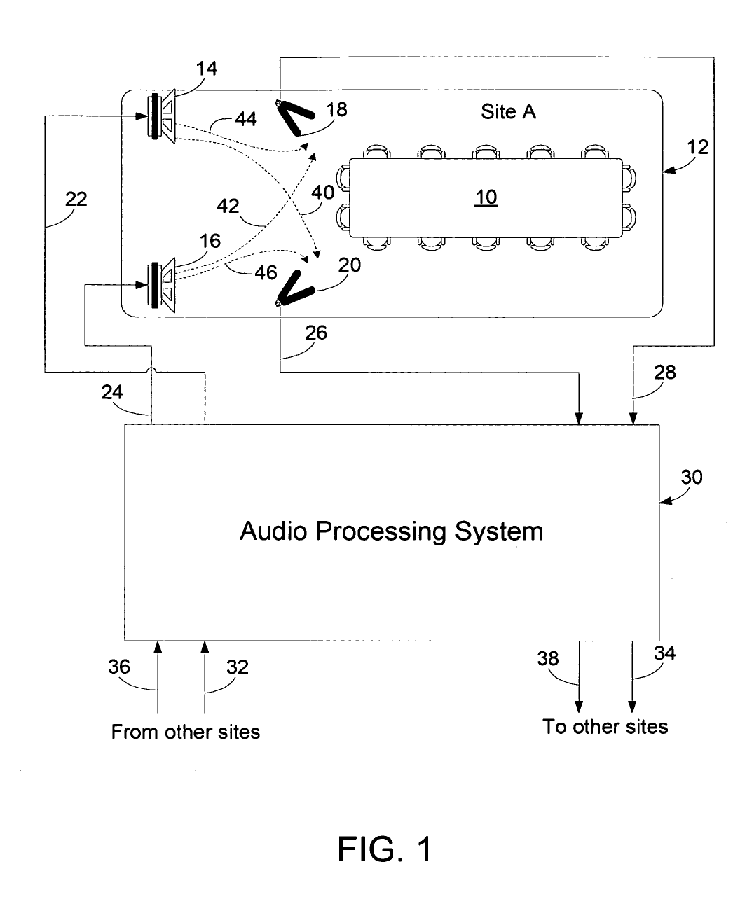

In FIG. 1, an audio processing system (APS) 30 is set up for stereo audio conferencing in a room 12 at Site A. Room 12 contains a table-and-chairs set 10, two speakers 14 and 16, and two microphones 18 and 20. APS 30 receives an inbound left audio channel 36 and an inbound right audio channel 32 from the other sites involved in a conference. APS 30 drives left speaker 16 with processed inbound left audio channel 24. APS 30 drives right speaker 14 with processed inbound right audio channel 22. Left microphone 20 generates an outbound left audio channel 26 and sends it to APS 30. Right microphone 20 generates an outbound right audio channel 28 and sends it to APS 30. APS 30 transmits a processed outbound left audio channel 38 to other sites in the conference. APS 30 transmits a processed outbound right audio channel 34 to other sites in the conference.

An effective audio conferencing system must minimize acoustic echoes associated with any of the four paths, 40, 42, 44, and 46, from a speaker to a microphone. The acoustic echoes may be reduced by directional microphones and/or speakers. Using careful placement and mechanical or phased-array technology, microphones 18 and 20 may be made sensitive in the direction of participants at table-and-chairs set 10, but insensitive to the output of speakers 14 and 16. Similarly, careful placement and mechanical or phased-array technology may be used to aim the output of speakers 14 and 16 at participants while minimizing direct stimulation of the microphones 18 and 20. Nevertheless, sound bounces and reflects throughout room 12 and some undesirable acoustic echoes find their way from speaker to microphone as represented by the paths, 40, 42, 44, and 46.

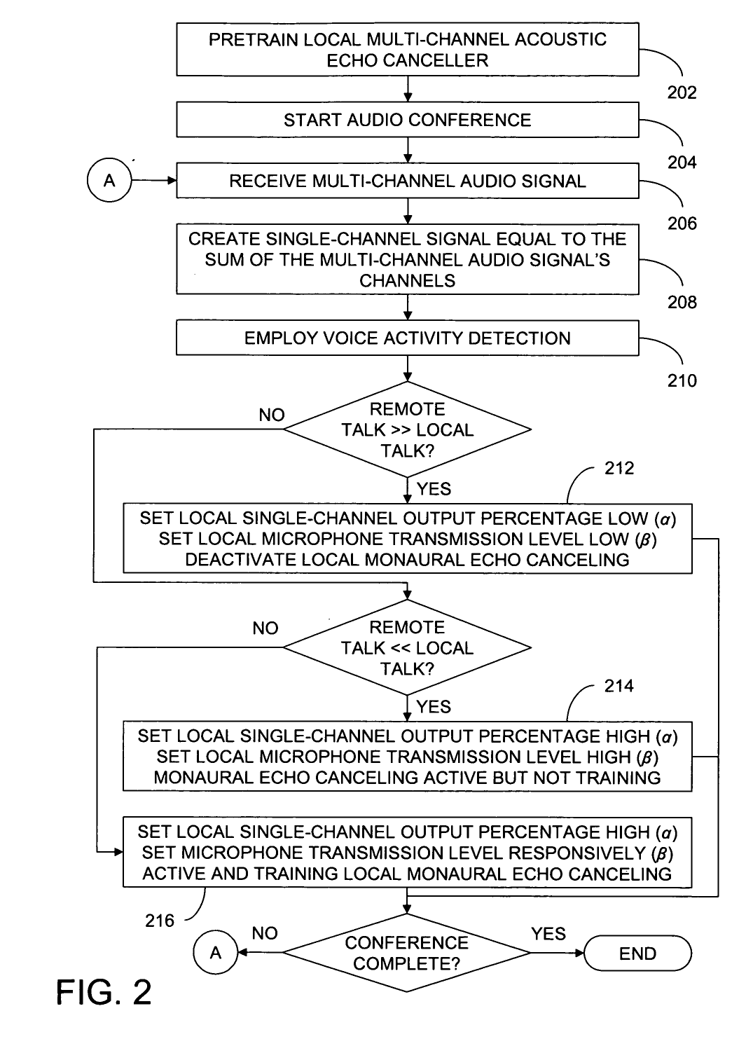

FIG. 2 depicts a process flow diagram of an audio conferencing method for varying the proportion of single-channel vs. multi-channel output of local loudspeakers, in accordance with an embodiment of the present invention. A multi-channel acoustic echo canceller (AEC) is pre-trained 202 before the start of an audio conference 204. Once the audio conference has begun, a multi-channel audio signal is received 206. A single-channel signal is created by summing the multi-channel audio signal's channels 208. Voice activity detection (VAD) is employed 210.

If the VAD of step 210 indicates that remote voice activity dominates local voice activity, then a local single-channel output percentage (α) is set low, a local microphone transmission level (β) is set low, and local monaural echo canceling is deactivated 212. From step 212, and while the audio conference continues, the process continues to receive a multi-channel audio signal 206 and to flow as shown from there.

If the VAD of step 210 indicates that remote voice activity is dominated by local voice activity, then the local single-channel output percentage (α) is set high, the local microphone transmission level (β) is set high, and local monaural echo canceling is active but not training 214. From step 214, and while the audio conference continues, the process continues to receive a multi-channel audio signal 206 and to flow as shown from there.

If the VAD of step 210 indicates that neither remote voice activity nor local voice activity dominates the other, then the local single-channel output percentage (α) is set high, the local microphone transmission level (β) is set responsively, and local monaural echo canceling is active and training 216. From step 216, and while the audio conference continues, the process continues to receive a multi-channel audio signal 206 and to flow as shown from there.

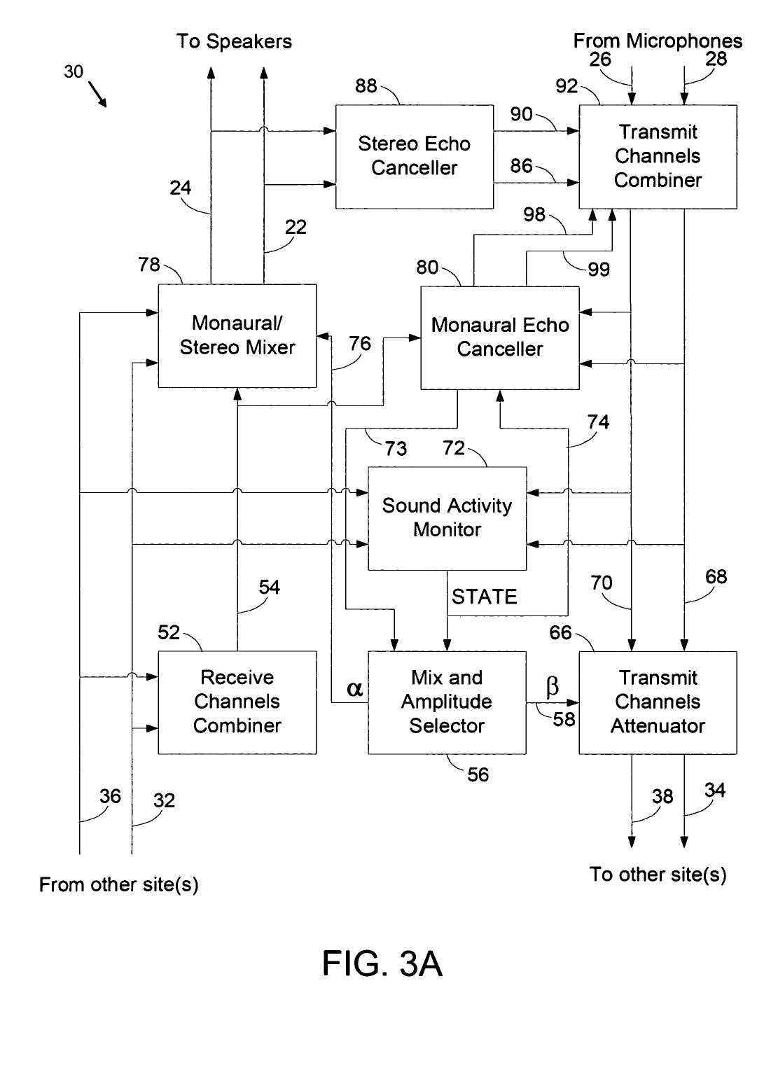

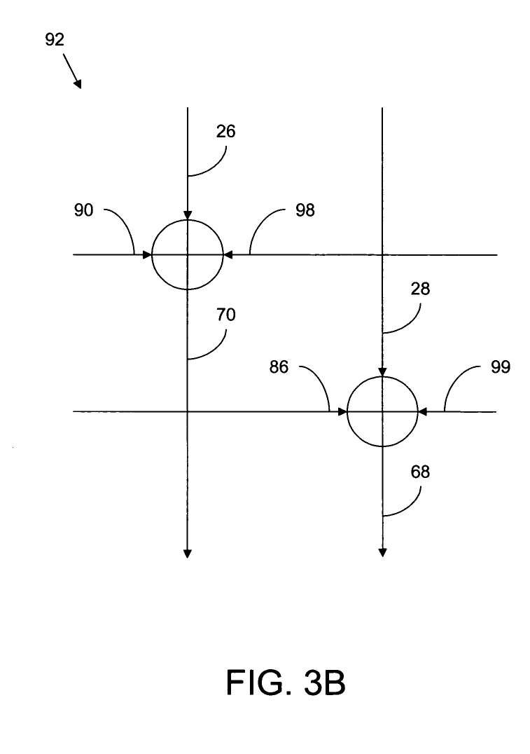

The internal structure of APS 30 is shown in FIG. 3A. This structure may be implemented in a software program or in hardware or in some combination of the two. Left channel 36 and right channel 32 are received by a Receive Channels Combiner 52, a Monaural/Stereo Mixer 78, and a Sound Activity Monitor 72. Receive Channels Combiner 52 adds channels 36 and 32 together to form a monaural version 54 of the received audio information. Monaural version 54 is communicated to Mixer 78 and a Monaural Echo Canceller 80. Mixer 78 combines monaural version 54 and channels 36 and 32 with a carefully selected proportion α to drive speakers 16 and 14 with left channel 24 and right channel 22, respectively.

FIG. 3B shows the inner workings of the Transmit Channels Combiner 92 of FIG. 3A. In particular, left channel 26 from microphone 20 and right channel 28 from microphone 18 enter a Transmit Channels Combiner 92. Transmit Channels Combiner 92 combines left channel 26 with a stereo left channel canceling signal 90 and a monaural left channel canceling signal 98 to produce internal left transmit channel 70. Transmit Channels Combiner 92 combines right channel 28 with a stereo right channel canceling signal 86 and a monaural right channel canceling signal 99 to produce internal right transmit channel 68. Returning to FIG. 3A, a Transmit Channels Attenuator 66 reduces the amplitude of channels 70 and 68 with a carefully selected proportion β to generate outbound channels 38 and 34, respectively.

A Stereo Echo Canceller 88 has been pre-trained with independent audio channels. It is active, but not adaptive, during normal operation. Stereo Echo Canceller 88 monitors processed inbound channels 24 and 22 to produce canceling signals 90 and 86, respectively.

Monaural Echo Canceller 80 monitors monaural version 54 of the inbound audio to produce canceling signals 98 and 99. Monaural Echo Canceller 80 trains by monitoring internal transmit channels 70 and 68 for residual echo errors. Canceller 80 is controlled by a STATE signal 74 from Sound Activity Monitor 72 as shown in Table 1 below.

TABLE 1

| | Local | Remote | Neither Local |
|---|---|---|---|
| | Source(s) | Source(s) | Nor Remote |
| STATE | Dominant | Dominant | Dominant |
| α | High | Low | High |
| β | High | Low | Responsive |
| Monaural EC | Active, Not | Inactive | Active, |
| | Training | | Training |

Sound Activity Monitor 72 monitors inbound channels 36 and 32 and internal transmit channels 70 and 68 to determine the STATE of sound activity as shown in row 1 of Table 1. The STATE is “Local Source(s) Dominant” when sound activity from local sources, detectable in the outbound channels, is high enough to indicate speech from a local participant, or other intentional audio communication from a local source, and inbound channels show sound activity from remote sources that is low enough to indicate only background noise, such as air conditioning fans or electrical hum from lighting. The STATE is “Remotes Source(s) Dominant” when the sound activity from remote sources, detectable in the inbound channels, is high enough to indicate speech from a remote participant, or other intentional audio communication from a remote source, and outbound channels show sound activity from local sources that is low enough to indicate only background noise, such as air conditioning fans or electrical hum from lighting. The STATE is “Neither Local Nor Remote Dominant” when the sound activity detected in both inbound and outbound channels is high enough to indicate intentional audio communication in both directions.

In order to distinguish intentional audio communication, especially voices, from background noise, Sound Activity Monitor 72 may measure the level of sound activity of an audio signal in a channel by any number of known techniques. These may include measuring total energy level, measuring energy levels in various frequency bands, pattern analysis of the energy spectra, counting the zero crossings, estimating the residual echo errors, or other analysis of spectral and statistical properties. Many of these techniques are specific to the detection of the sound of speech, which is very useful for typical audio conferencing.

A Mix and Amplitude Selector 56 selects proportions α and β in response to STATE signal 74 and residual echo error signal 73. Proportion α is selected from the range 0 to 1 in accordance with row 2 of Table 1, and communicated to Mixer 78 via signal 76. Proportion β is selected from the range 0 to 1in accordance with row 3 of Table 1, and communicated to Attenuator 66 via signal 58.

Proportion α determines how much common content will be contained in processed inbound channels 24 and 22. When α is high, that is, at or near 1, the output of speakers 16 and 14 is predominantly monaural. When α is low, that is, at or near 0, the output of speakers 16 and 14 is predominantly stereo. The exact values of a selected for the high and low conditions may depend on empirical tests of user preference and on the amount of residual echo error left uncorrected by Stereo Echo Canceller 88, as determined by how much echo remains for Monaural Echo Canceller 80 to correct. The amount of residual echo error is communicated from Monaural Echo Canceller 80 to Mix and Amplitude Selector 56 via signal 73. If there is little residual error, the values of a may be adjusted lower to favor stereo and provide more spatial information to the participants. If the residual error is high, the values of α may be adjusted higher to favor monaural and rely more on Monaural Echo Canceller 80.

Whenever α is high, Monaural Echo Canceller 80 is active. When the sound activity of incoming channels 36 and 32 is also high enough to provide reliable error estimation (that is, STATE is “Neither Local Nor Remote Dominant”), Monaural Echo Canceller 80 is also trained.

Proportion β determines the levels of processed outbound channels 38 and 34. This control provides a kind of noise suppression. When STATE is “Local Source(s) Dominant”, Attenuator 66 transmits at or near maximum amplitude. When STATE is “Remote Source(s) Dominant” and local sources consist of background noise only, Attenuator 66 sets the amplitude at or near zero to prevent the transmission of distracting background noise, including residual echoes that are not attenuated by Stereo Echo Canceller 88, to remote sites. When there is intentional audio communication in both directions, β is adjusted dynamically in response to the relative levels in the two directions.

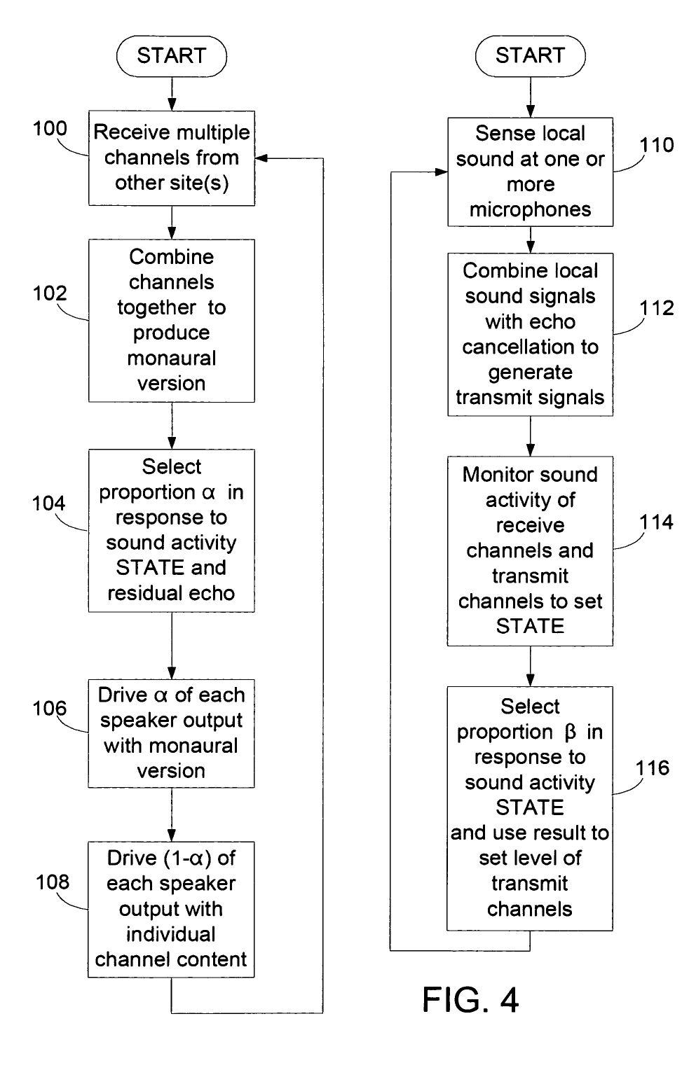

Another view of the processing of incoming audio is given in a flowchart on the left side of FIG. 4. In step 100, inbound audio channels are received by Audio Processing System 30. Receive Channels Combiner 52 combines the inbound audio channels into monaural version 54 in step 102. Mix and Amplitude Selector 56 selects proportion a in step 104 in response to sound activity STATE and to local residual echo error. Mixer 78 drives α of each speaker's output with monaural version 54 (step 106), while driving (1−α) of each speaker's output with the appropriate individual channel content (step 108).

Another view of the processing of outbound audio is given in a flowchart on the right side of FIG. 4. In step 110, microphones sense local sound for input to APS 30. Transmit Channels Combiner 92 combines echo cancellation signals with local sound signals in step 112 to produce internal transmit channels 70 and 68. Monitor 72 senses the internal transmit channels and inbound channels 36 and 32 to determine the sound activity STATE in step 114. Selector 56 selects proportion β in response to the sound activity STATE and Attenuator 66 uses β to set the level of the outbound channels to other sites in step 116.

### Variations

An audio frequency bandwidth may be divided into any number of smaller frequency sub-bands. For example, an 8 kilohertz audio bandwidth may be divided into four smaller sub-bands: 0-2 kilohertz, 2-4 kilohertz, 4-6 kilohertz, and 6-8 kilohertz. Audio echo cancellation and noise suppression, in particular the methods of the present invention, may be applied in parallel to multiple sub-bands simultaneously. This may be advantageous because acoustic echoes and background noise are often confined to certain specific frequencies rather than occurring evenly throughout the spectrum of an audio channel.

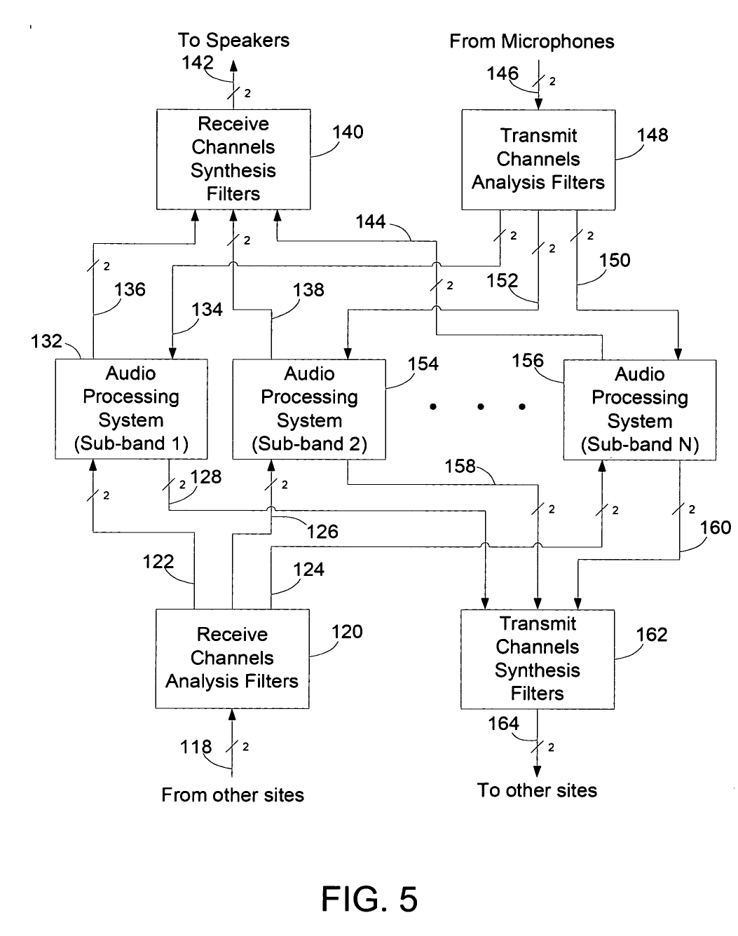

In FIG. 5, Audio Processing Systems (APS's) 132, 154, 156, and others like them operate in parallel in N sub-bands of the audio bandwidth of a stereo conferencing system. Inbound stereo channel 118 is divided by Receive Channels Analysis Filters 120 into N inbound sub-band stereo channels 122, 126, 124, and others like them. Each of the inbound sub-band stereo channels is received by one of the APS's. Each APS generates one of N processed inbound sub-band stereo channels 136, 138, 144, and others like them. Receive Channels Synthesis Filters 140 combine the N processed inbound sub-band stereo channels into stereo channel 142 which drives two speakers.

Stereo channel 146 from two microphones is divided by Transmit Channels Analysis Filters 148 into N outbound sub-band stereo channels 134, 152, 150, and others like them. Each of the N outbound sub-band stereo channels is processed by one of the APS's 132, 154, 156, and others like them to generate N processed outbound sub-band stereo channels 128, 158, 160, and others like them. Transmit Channels Synthesis Filters 162 combine the N processed outbound sub-band stereo channels into outbound stereo channel 164.

Audio Processing Systems 132, 154, 156, and the others like them operate using the same methods as APS 30, except that each is processing a frequency sub-band rather than the full audio bandwidth.

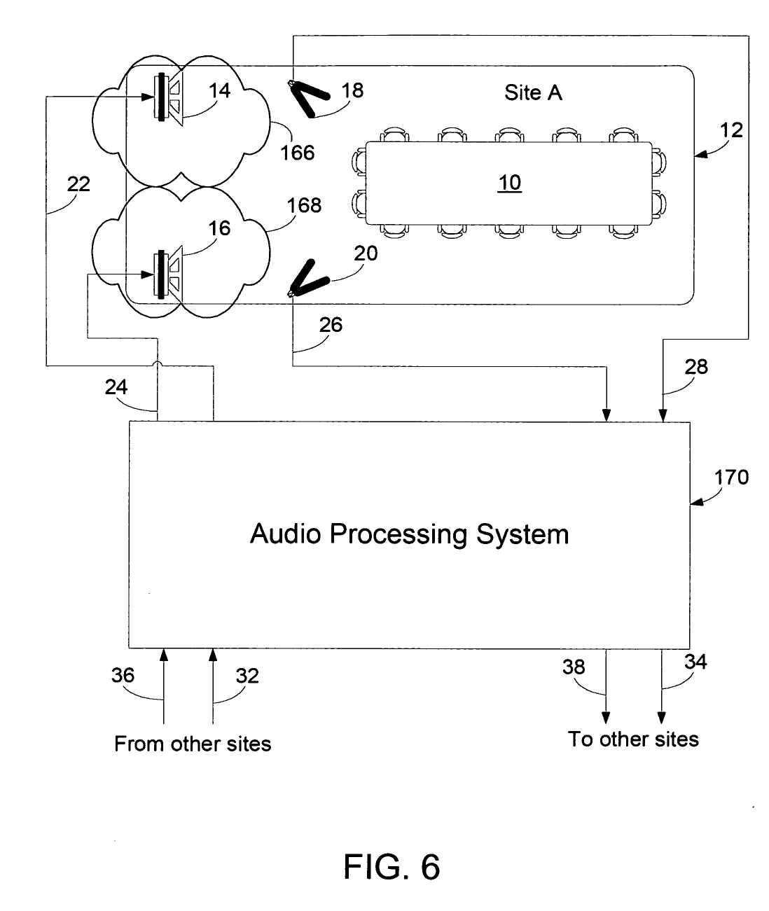

Stereo audio conferencing may be used to give a virtual local location to the sources of sound actually originating at each of the remote sites in a conference. Consider a three-way conference among sites A, B, and C. Assume that the specific source of all inbound audio information may be distinguished at local site A. FIG. 6 shows an arrangement very similar to the arrangement of FIG. 1. All physical objects and connections are the same, but in operation an APS 170 biases the outputs of speakers 16 and 14. Audio from remote site B is emitted somewhat louder than normal from speaker 16 relative to speaker 14, and audio from site C is emitted somewhat louder than normal from speaker 14 relative to speaker 16. Thus local participants seated at table-and-chairs set 10 perceive site B audio to be coming from region 168 of room 12, and they perceive site C audio to be coming from region 166 of room 12.

The methods disclosed herein operate effectively in this virtual location scheme with modest increase in complexity. APS 170 has the same structure as that of APS 30, as shown in FIG. 3A, but Monaural Echo Canceller 80 must be changed to use two different acoustic echo models for audio from the two different sites, and Sound Level Monitor 72 and Mix and Amplitude Selector 56 must change to use a more complex control than Table 1. The changed control table is Table 2 below.

Virtual locations may also be established using phased arrays of speakers. Such arrays can enlarge the volume of space within which the local participants perceive the intended virtual locations. It will be obvious to any person of ordinary skill in the relevant arts that the methods of the present invention may be applied in conjunction with phased-array speakers in a manner similar to application in conjunction with two stereo speakers as in FIG. 6.

TABLE 2
STATE: Local Source(s) Dominant

| | |
|---|---|
| α | High |
| β | High |
| Monaural EC | Active for Site B; Active for Site |
| | C; No Training |

STATE: Remote Source(s) Dominant

| | |
|---|---|
| α | Low |
| β | Low |
| Monaural EC | Inactive |

STATE: Neither Local Nor Remote Dominates the Other; No Site
Dominant Among Remote Sites

| | |
|---|---|
| α | High |
| β | Responsive to levels at all sites |
| Monaural EC | Active for Site B; Active for Site |
| | C; No Training |

STATE: Neither Local Nor Remote Dominates the Other; Site B
Dominant Among Remote Sites

| | |
|---|---|
| α | High |
| β | Responsive to levels at sites A |
| | and B |
| Monaural EC | Active for Site B; Training for |
| | Site B; Inactive for Site C |

STATE: Neither Local Nor Remote Dominates the Other; Site C
Dominant Among Remote Sites

| | |
|---|---|
| α | High |
| β | Responsive to levels at sites A |
| | and C |
| Monaural EC | Active for Site C; Training for Site |
| | C; Inactive for Site B |

In the examples described above, the present invention is applied to stereo (two channel) audio conferencing. It will be obvious to any person of ordinary skill in the relevant arts that the methods of the present invention may be applied to multi-channel audio conferencing systems having more than two channels.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing embodiments of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for selectively combining single-channel and multi-channel signals for loudspeaker output, comprising:
creating a single-channel signal based on an inbound multi-channel signal;
detecting a local voice activity level and a remote voice activity level;
if the remote voice activity level dominates the local voice activity level, setting a equal to a first percentage;
otherwise, setting a equal to a second percentage higher than the first percentage; and
mixing at least one speaker output signal comprising a proportion of the single-channel signal based on a and a proportion of the inbound multi-channel signal based on 1−α.

2. The method of claim 1, further comprising:
if the remote voice activity level dominates the local voice activity level, setting local microphone transmission level low;
if the remote voice activity level is dominated by the local voice activity level, setting local microphone transmission level high; and
otherwise, setting local microphone transmission level responsively.

3. The method of claim 1, further comprising:
if the remote voice activity level dominates the local voice activity level, deactivating local monaural echo canceling;
if the remote voice activity level is dominated by the local voice activity level, setting monaural echo canceling active but not training; and
otherwise, activating and training local monaural echo canceling.

4. The method of claim 1, further comprising:
pre-training a stereo echo canceller with independent audio channels; and
applying the pre-trained stereo echo canceller do reduce multi-channel echo during normal operations.

5. The method of claim 1, further comprising:
adjusting the level of the at least one speaker output signal based on the source of the inbound multi-channel signal.

6. A computer programming product for selectively combining single-channel and multi-channel signals for speaker output, comprising:
a memory;
logic stored on the memory, for:
creating a single-channel signal based on an inbound multi-channel signal,
detecting a local voice activity level and a remote voice activity level,
if the remote voice activity level dominates the local voice activity level, setting a equal to a first percentage,
otherwise, setting a equal to a second percentage higher than the first percentage; and
mixing a loudspeaker output signal comprising a first proportion of the single-channel signal based on α and a second proportion of the inbound multi-channel signal based on 1−α.

7. The product of claim 6, further comprising logic stored on the memory, for:
if the remote voice activity level dominates the local voice activity level, setting local microphone transmission level low;
if the remote voice activity level is dominated by the local voice activity level, setting local microphone transmission level high; and
otherwise, setting local microphone transmission level responsively.

8. The product of claim 6, further comprising logic stored on the memory, for:
if the remote voice activity level dominates the local voice activity level, deactivating local monaural echo canceling;
if the remote voice activity level is dominated by the local voice activity level, setting monaural echo canceling active but not training; and
otherwise, activating and training local monaural echo canceling.

9. The product of claim 6, further comprising logic stored on the memory, for:
pre-training a stereo echo canceller with independent audio channels; and
applying the pre-trained stereo echo canceller to reduce stereo echo during operations including multi-channel loudspeaker output.

10. The product of claim 6, further comprising logic stored on the memory, for:
adjusting the level of the loudspeaker output signal based on the source of the inbound multi-channel signal.

11. An apparatus for selectively combining single-channel and multi-channel signals for loudspeaker output, comprising:
a receive combiner configured to create a combined monaural signal from at least two inbound channel signals;
a sound activity monitor configured to produce a first state signal if the at least two inbound signal's source dominates an internal transmit signal's source;
a mix and amplitude selector adapted to output an a signal representing a first value if the first state signal is received and, otherwise, a second value higher than the first value; and
a monaural and stereo mixer adapted to output a loudspeaker signal comprising a proportion of the combined monaural signal based on α and a proportion of the at least two inbound channel signals based on 1−α.

12. The apparatus of claim 11, wherein the mix and amplitude selector is further adapted to:
if the remote voice activity level dominates the local voice activity level, set local microphone transmission level low;
if the remote voice activity level is dominated by the local voice activity level, set local microphone transmission level high; and
otherwise, set local microphone transmission level responsively.

13. The apparatus of claim 11, wherein the mix and amplitude selector is further adapted to:
if the remote voice activity level dominates the local voice activity level, deactivate local monaural echo canceling;
if the remote voice activity level is dominated by the local voice activity level, set monaural echo canceling active but not training; and
otherwise, activate and train local monaural echo canceling.

14. The apparatus of claim 11, further comprising:
a pre-trained stereo echo canceller adapted to reduce stereo echo during operations including multi-channel loudspeaker output.

15. The apparatus of claim 11, wherein the monaural and stereo mixer is further adapted to:
adjust the level of the loudspeaker output signal based on the source of the inbound multi-channel signal.

16. A system for selectively combining single-channel and multi-channel signals for loudspeaker output, comprising:
an analysis filter associated with a receive channel and adapted to direct an inbound multi-channel signal to one of a plurality of apparatuses based on the frequency of the inbound multi-channel signal, wherein each such apparatus further comprises:
a receive combiner configured to create a combined monaural signal from at least two inbound channel signals;
a sound activity monitor configured to produce a first state signal if the at least two inbound signal's source dominates an internal transmit signal's source;
a mix and amplitude selector adapted to output an a signal representing a first value if the first state signal is received and, otherwise, a second value higher than the first value; and
a monaural and stereo mixer adapted to output a loudspeaker signal comprising a proportion of the combined monaural signal based on α and a proportion of the at least two inbound channel signals based on 1−α.

17. The system of claim 16, wherein each apparatus's mix and amplitude selector is further adapted to:
if the remote voice activity level dominates the local voice activity level, set local microphone transmission level low;
if the remote voice activity level is dominated by the local voice activity level, set local microphone transmission level high; and
otherwise, set local microphone transmission level responsively.

18. The system of claim 16, wherein each apparatus's mix and amplitude selector is further adapted to:
if the remote voice activity level dominates the local voice activity level, deactivate local monaural echo canceling;
if the remote voice activity level is dominated by the local voice activity level, set monaural echo canceling active but not training; and
otherwise, activate and train local monaural echo canceling.

19. The system of claim 16, wherein each apparatus further comprises:
a pre-trained stereo echo canceller adapted to reduce stereo echo during operations including multi-channel loudspeaker output.

20. The system of claim 16, wherein each apparatus's monaural and stereo mixer is further adapted to:
adjust the level of the loudspeaker output signal based on the source of the inbound multi-channel signal.
